(19) United States
(12) Patent Application Publication
(10) Pub. No.: US 2008/0002770 A1
(43) Pub. Date: Jan. 3, 2008

(54) METHODS, APPARATUS, AND A COMPUTER PROGRAM PRODUCT FOR PROVIDING A FAST INTER MODE DECISION FOR VIDEO ENCODING IN RESOURCE CONSTRAINED DEVICES

(75) Inventors: Kemal Ugur, Tampere (FI); Jani Lainema, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/428,151

(22) Filed: Jun. 30, 2006

(51) Int. Cl. H04N 11/02; H04N 11/04

(52) U.S. Cl. 375/240.16; 375/240.24

(57) ABSTRACT

A device for reducing the number of motion estimation operations in performing motion compensated prediction includes a motion estimator, a motion compensated prediction device and a processing element. The motion estimator is configured to extract a motion vector from a macroblock of a video frame. The macroblock includes inter modes which are block sizes. The motion compensated prediction device is configured to generate a prediction macroblock based on the motion vector by analyzing a corresponding macroblock in a reference frame. The processing element communicates with the motion estimator and the motion compensated prediction device. The processing element also compares a distortion value to a first predetermined threshold and selects a first encoding mode among first and second encoding modes without evaluating the second encoding mode based upon the comparison of the distortion value to the first predetermined threshold.

### TECHNOLOGICAL FIELD

Embodiments of the present invention relate generally to mobile electronic device technology and, more particularly relate to methods, apparatuses, and a computer program product for providing a fast INTER mode decision algorithm to decrease the encoding complexity of video encoding without a significant decrease in video coding efficiency.

### BACKGROUND

The modern communications era has brought about a tremendous expansion of wireline and wireless networks. Computer networks, television networks, and telephony networks are experiencing an unprecedented technological expansion fueled by consumer demand. Wireless and mobile networking technologies have addressed related consumer demands, while providing more flexibility and immediacy of information transfer.

Current and future networking technologies continue to facilitate ease of information transfer and convenience to users. One such expansion in the capabilities of mobile electronic devices relates to an ability of such devices to process video data such as video sequences. The video sequence may be provided from a network server or other network device, to a mobile terminal such as, for example, a mobile telephone, a portable digital assistant (PDA), a mobile television, a video-iPOD, a mobile gaming system, etc., or even from a combination of the mobile terminal and the network device.

Video sequences typically consist of a large number of video frames, which are formed of a large number of pixels each of which is represented by a set of digital bits. Because of the large number of pixels in a video frame and the large number of video frames in a typical video sequence, the amount of data required to represent the video sequence is large. As such, the amount of information used to represent a video sequence is typically reduced by video compression (i.e., video coding). For instance, video compression converts digital video data to a format that requires fewer bits which facilitates efficient storage and transmission of video data. H.264/AVC (Advanced Video Coding) (also referred to as AVC/H.264 or H.264/MPEG-4 Part 10 or MPEG-4 Part 10/H.264 AVC) is a video coding standard that is jointly developed by ISO/MPEG and ITU-T/VCEG study groups which achieves considerably higher coding efficiency than previous video coding standards (e.g., H.263). Particularly, H.264/AVC achieves significantly better video quality at similar bitrates than previous video coding standards. Due to its high compression efficiency and network friendly design, H.264/AVC is gaining momentum in industry ranging from third generation mobile multimedia services, digital video broadcasting to handheld (DVB-H) to high definition digital versatile discs (HD-DVD). However, as fully appreciated by those skilled in the art, H.264 achieves increased coding efficiency at the expense of increased complexity at the H.264 encoder as well as the H.264 decoder.

Currently, releases of several mobile multimedia standards are underway which will implement H.264 encoding functionality in handsets. Given that handsets have limited space, limited computational power and limited resources, it is imperative that handsets employing H.264 have low-complexity encoding for a number of reasons. First, low-complexity encoding decreases the resource consumption of video encoders in the handset thereby increasing the battery life of the handset. Second, if encoding of a certain video frame takes more time to encode that an allocated time, the video frame may be skipped. As such, the maximum complexity of encoding a video frame should be reduced, as well as the average encoding complexity.

The complexity of the H.264 encoder is in large part due to Motion Compensated Prediction (MCP). Motion Compensated Prediction is a widely recognized technique for compression of video data and is typically used to remove temporal redundancy between successive video frames (i.e., interframe coding). Temporal redundancy typically occurs when there are similarities between successive video frames within a video sequence. For instance, the change of the content of successive frames in a video sequence is by and large the result of motion in the scene of the video sequence. The motion may be due to movement of objects present in the scene or camera motion. Typically, only the differences (e.g., motion or movements) between successive frames will be encoded. Motion Compensated Prediction removes the temporal redundancy by estimating the motion of a video sequence using parameters of a segment in a previously encoded frame (for example, a frame preceding the current frame). In other words, Motion Compensated Prediction allows a frame to be generated (i.e., predicted frame) based on motion vectors of a previously encoded frame which may serve as a reference frame.

As fully appreciated by those skilled in the art, a video frame may be segmented or divided into macroblocks and Motion Compensated Prediction may be performed on the macroblocks. For each macroblock of the video frame, motion estimation may be performed and a predicted macroblock may be generated based on a motion vector corresponding to a matching macroblock in a previously encoded frame which may serve as a reference frame.

Unlike previous video coding standards, in the H.264/AVC video coding standard, a macroblock can be divided into various block partitions of a 16×16 block and a different motion vector corresponding to each partition of the macroblock may be generated. A different motion vector corresponding to each partition of a macroblock is generated because the H.264/AVC defines new INTER modes or block sizes for a macroblock. Specifically, as shown in FIG. 1, the H.264/AVC video coding standard allows various block partitions of a 16×16 macroblock and defines new INTER modes, namely, INTER_{—}16×16, INTER_{—}16×8, INTER_{—}8×16 and INTER_{—}8×8 of a 16×16 mode macroblock. Additionally, as shown in FIG. 1, H.264/AVC video coding standard allows various partitions of a 8×8 sub-macroblock and defines new INTER sub-modes, namely, INTER_{—}8×8, INTER_{—}8×4, INTER_{—}4×8, and INTER_{—}4×4 of a 8×8 sub-mode sub-macroblock. Consider the INTER_{—}16×8 mode, in this INTER mode a macroblock is horizontally divided into two partitions and a motion vector is transmitted for each partition, resulting in two motion vectors for the macroblock. In this regard, H.264/AVC generates more accurate representation of motion between two frames and significantly increases coding efficiency.

Since H.264/AVC defines an increased number of INTER modes, the H.264 encoder is required to check more modes than previous video coding standards to find the best mode. For each candidate mode, motion estimation needs to be performed for all partitions of the macroblock thereby increasing the number of motion estimation operations drastically. For each candidate mode, motion estimation must be performed for all the partitions of the macroblock which increases the number of motion estimation operations tremendously and thereby increases the complexity of the H.264 encoder. The increased number of motion estimation operations increases resource consumption of an H.264 encoder and decreases the battery life of a mobile terminal employing the H.264 encoder.

In order to reduce the complexity of a Motion Compensated Prediction step at an encoder, the number of motion estimation operations should be reduced. This could be achieved by disabling all INTER modes except INTER_{—}16×16 and only performing motion estimation for the INTER_{—}16×16 mode. However, as can be seen in FIG. 2, a penalty in coding efficiency occurs if INTER _{—}16×8 and INTER_{—}8×16 modes are disabled. As shown in FIG. 2, for a given video sequence (e.g., a video clip titled “Foreman” encoded in QCIF (Quarter Common Intermediate Format),176×144 resolution in 15 frames-per-second) in which motion estimation is performed for INTER_{—}16×16, INTER_{—}16×8 and INTER_{—}8×16 modes, a higher peak signal-to-noise ratio (PSNR) (measured in decibels) at a given bitrate (kilobits/second) is achieved as opposed to the situation in which motion estimation is only performed for the INTER_{—}16×16 mode. In this regard, disabling all INTER modes except the INTER_{—}16×16 mode results in significant coding efficiency drop.

As such, there is a need for a fast INTER mode decision algorithm to decrease the encoding complexity of the H.264 encoder by reducing the number of motion estimation operations without experiencing a significant decrease in coding efficiency.

### BRIEF SUMMARY

A method, apparatus and computer program product are therefore provided which implements a fast INTER mode decision algorithm capable of examining and processing variable sized macroblocks which may have one or more partitions. The method, apparatus and computer program product reduce the number of motion estimation operations associated with motion compensated prediction of an encoder. In this regard, the complexity of the encoder is reduced without experiencing a significant decrease in coding efficiency. Accordingly, a cost savings may be realized due to the reduced number of motion estimation operations of the encoder. The fast INTER mode decision algorithm of the invention may be implemented in the H.264/AVC video coding standard or any other suitable video coding standard capable of facilitating variable sized macroblocks.

In one exemplary embodiment, methods for reducing the number of motion estimation operations in performing motion compensated prediction are provided. Initially, it is determined whether at least one motion vector is extracted from at least one macroblock of a video frame. The at least one macroblock includes a first plurality of inter modes having a plurality of block sizes. At least one prediction for the macroblock is then generated based on the at least one motion vector by analyzing a reference frame. It is then determined whether the extracted motion vector is substantially equal to zero and, if so, a distortion value is calculated based on a difference between the at least one prediction macroblock and the at least one macroblock. The distortion value is then compared to a first predetermined threshold and, when the distortion value is less than the first predetermined threshold, a first encoding mode is selected from among first and second encoding modes without evaluating the second encoding mode. By not evaluating the second encoding mode, the efficiency of the encoding process is improved.

In another exemplary embodiment, a device for reducing the number of motion estimation operations in performing motion compensated prediction is provided. The device includes a motion estimator, a motion compensated prediction device and a processing element. The motion estimator is configured to extract at least one motion vector from at least one macroblock of a video frame. The at least one macroblock includes a first plurality of inter modes having a plurality of block sizes. The motion compensated prediction device is configured to generate at least one prediction for the at least one macroblock based on the at least one motion vector by analyzing a reference frame. The processing element communicates with the motion estimator and the motion compensated prediction device. The processing element is also configured to determine whether the extracted motion vector is substantially equal to zero. The processing element is further configured to calculate a distortion value based on a difference between the at least one prediction macroblock and the at least one macroblock when the extracted motion vector is substantially equal to zero. The processing element is also configured to compare the distortion value to a first predetermined threshold and, when the distortion value is less than the first predetermined threshold, the processing element is further configured to select a first encoding mode among first and second encoding modes without evaluating the second encoding mode.

According to other embodiments, a corresponding computer program product for reducing the number of estimation operations in performing motion compensated prediction is provided in a manner consistent with the foregoing method.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is an illustration of INTER modes supported in the H.264/AVC Video Coding Standard;

FIG. 2 is a graphical representation of coding efficiency drop when INTER Modes 16×8 and 8×16 are disabled;

FIG. 3 is a schematic block diagram of a mobile terminal according to an exemplary embodiment of the present invention;

FIG. 4 is a schematic block diagram of a wireless communications system according to an exemplary embodiment of the present invention;

FIG. 5 is a schematic block diagram of an encoder according to exemplary embodiments of the invention;

FIG. 6 is a schematic block diagram of a motion compensated prediction module according to exemplary embodiments of the present invention;

FIG. 7 is an illustration showing the numbering of 8×8 blocks in a 16×16 macroblock;

FIG. 8 is an illustration showing a Binary Sum of Absolute Differences Map according to exemplary embodiments of the present invention;

FIGS. 9A and 9B are flowcharts illustrating various steps in a method of generating a fast INTER mode decision algorithm according to exemplary embodiments of the present invention;

FIG. 10 is a graphical representation showing rate distortion performance and average complexity reduction achieved by an exemplary embodiment of an encoder according to embodiments of the present invention versus a conventional encoder;

FIG. 11 is a graphical representation showing complexity reduction and coding efficiency of an exemplary encoder of the present invention versus a conventional encoder; and

FIG. 12 is graphical representation illustrating the encoding complexity of a frame according an exemplary embodiment of an encoder of the present invention versus a conventional encoder.

### DETAILED DESCRIPTION OF THE INVENTION

Embodiments of the present inventions will now be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

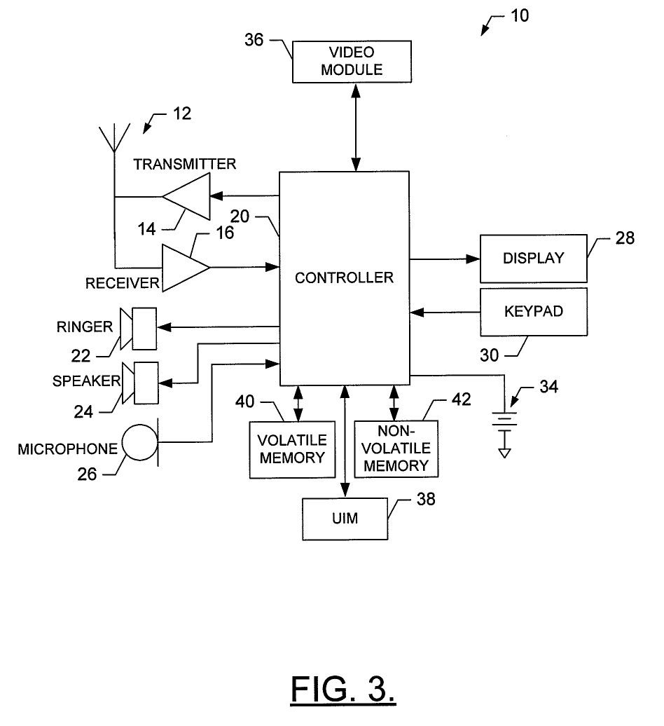

FIG. 3 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 may be a video telephone and include a video module 36 in communication with the controller 20. The video module 36 may be any means for capturing video data for storage, display or transmission. For example, the video module 36 may include a digital camera capable of forming a digital image file from a captured image. Additionally, the digital camera may be capable of forming video image files from a sequence of captured images. As such, the video module 36 includes all hardware, such as a lens or other optical device, and software necessary for creating a digital image file from a captured image and for creating video image files from a sequence of captured images. Alternatively, the video module 36 may include only the hardware needed to view an image or video data (e.g., video sequences, video stream, video clips, etc.), while a memory device of the mobile terminal 10 stores instructions for execution by the controller 20 in the form of software necessary to create a digital image file from a captured image. The memory device of the mobile terminal 10 may also store instructions for execution by the controller 20 in the form of software necessary to create video image files from a sequence of captured images. Image data as well as video data may be shown on a display 28 of the mobile terminal. In an exemplary embodiment, the video module 36 may further include a processing element such as a co-processor which assists the controller 20 in processing video data and an encoder and/or decoder for compressing and/or decompressing image data and/or video data. The encoder and/or decoder may encode and/or decode video data according to the H.264/AVC video coding standard or any other suitable video coding standard capable of supporting variable sized macroblocks.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

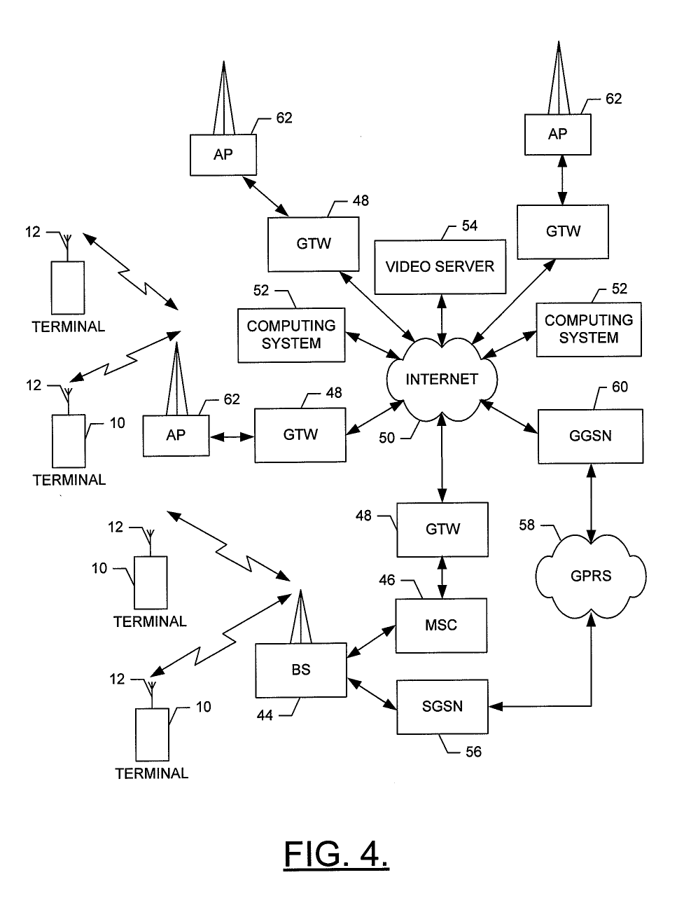

Referring now to FIG. 4, an illustration of one type of system that would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 4, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 4), video server 54 (one shown in FIG. 4) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or video server 54 may be coupled to the mobile terminal 10 via the Internet 50, SGSN 56 and GGSN 60. In this regard, devices such as the computing system 52 and/or video server 54 may communicate with the mobile terminal 10 across the SGSN 56, GPRS core network 58 and the GGSN 60. By directly or indirectly connecting mobile terminals 10 and the other devices (e.g., computing system 52, video server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the video server 54, and/or any of a number of other devices, to the Internet 50, the mobile terminals 10 can communicate with one another, the computing system, video server, etc., to thereby carry out various functions of the mobile terminals 10, such as to transmit data, content or the like to, and/or receive content, data or the like from, the computing system 52 and/or video server 54. For example, the video server 54 may provide video data to one or more mobile terminals 10 subscribing to a video service. This video data may be compressed according to the H.264/AVC video coding standard. The video server 54 may function as a gateway to an online video store or it may comprise previously recorded video clips. The video server 54 can be capable of providing one or more video sequences in a number of different formats including for example, Third Generation Platform (3GP), AVI (Audio Video Interleave), Windows Media®, MPEG (Moving Pictures Expert Group, Quick Time®, Real Video®, Shockwave® (Flash®) or the like). As used herein, the terms “video data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 4, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

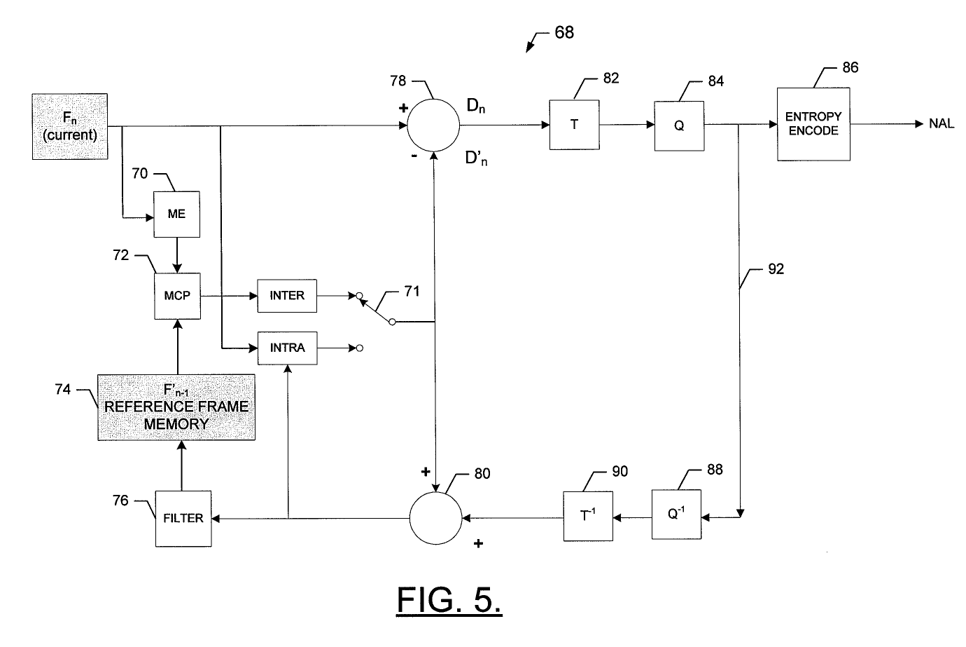

An exemplary embodiment of the invention will now be described with reference to FIG. 5, in which elements of an encoder capable of implementing a fast INTER mode decision algorithm to decrease the encoding complexity by reducing the number of motion estimation operations without experiencing a significant decrease in coding efficiency is shown. The encoder 68 of FIG. 5 may be employed, for example, in the mobile terminal 10 of FIG. 3. However, it should be noted that the encoder of FIG. 5 may also be employed on a variety of other devices, both mobile and fixed, and therefore, the present invention should not be limited to application on devices such as the mobile terminal 10 of FIG. 3 although an exemplary embodiment of the invention will be described in greater detail below in the context of application in a mobile terminal. Such description below is given by way of example and not of limitation. For example, the encoder of FIG. 5 may be employed on a computing system 52, a video recorder, such as a DVD player, HD-DVD players, Digital Video Broadcast (DVB) handheld devices, personal digital assistants (PDAs), digital television set-top boxes, gaming and/or media consoles, etc. Furthermore, the encoder 68 of FIG. 5 may be employed on a device, component, element or video module 36 of the mobile terminal 10. The encoder 68 may be any device or means embodied in either hardware, software, or a combination of hardware and software that is capable of encoding a video sequence having a plurality of video frames. In an exemplary embodiment, the encoder 68 may be embodied in software instructions stored in a memory of the mobile terminal 10 and executed by the controller 20. In an alternative exemplary embodiment, the encoder 68 may be embodied in software instructions stored in a memory of the video module 36 and executed by a processing element of the video module 36. It should also be noted that while FIG. 5 illustrates one example of a configuration of the encoder, numerous other configurations may also be used to implement embodiments of the present invention.

Referring now to FIG. 5, an encoder 68, as generally known to those skilled in the art that is capable of encoding an incoming video sequence is provided. As shown in FIG. 5, an input video frame Fₙ (transmitted from a video source such as a video server 54) is received by the encoder 68. The input video frame Fₙ is processed in units of a macroblock. The input video frame Fₙ is supplied to the positive input of a difference block 78 and the output of the difference block 78 is provided to a transformation block 82 so that a set of transform coefficients based on the input video frame Fₙ can be generated. The set of transform coefficients are then transmitted to a quantize block 84 which quantizes each input video frame to generate a quantized frame having a set of quantized transform coefficients. Loop 92 supplies the quantized frame to inverse quantize block 88 and inverse transformation block 90 which respectively perform inverse quantization of the quantized frames and inverse transformation of the transform coefficients. The resulting frame output from inverse transformation block 90 is sent to a summation block 80 which supplies the frame to filter 76 in order to reduce the effects of blocking distortion. The filtered frame may serve as a reference frame and may be stored in reference frame memory 74. As shown in FIG. 5, the reference frame may be a previously encoded frame F′ₙ₋₁ Motion Compensated Prediction (MCP) block 72 performs motion compensated prediction based on a reference frame stored in reference frame memory 74 to generate a prediction macroblock that is motion compensated based on a motion vector generated by motion estimation block 70. The motion estimation block 70 determines the motion vector from a best match macroblock in video frame Fₙ. The motion compensated block 72 shifts a corresponding macroblock in the reference frame based on this motion vector to generate the prediction macroblock.

The H.264/AVC video coding standard allows each macroblock to be encoded in either INTRA or INTER mode. In other words, the H.264/AVC video coding standard permits the encoder to choose whether to encode in the INTRA or INTER mode. In order to effectuate INTER mode coding, difference block 78 has a negative output coupled to MCP block 72 via selector 71. In this regard, the difference block 78 subtracts the prediction macroblock from the best match of a macroblock in the current video frame Fₙ to produce a residual or difference macroblock Dₙ. The difference macroblock is transformed and quantized by transformation block 82 and quantize block 84 to provide a set of quantized transform coefficients. These coefficients may be entropy encoded by entropy encode block 86. The entropy encoded coefficients together with residual data required to decode the macroblock, (such as the macroblock prediction mode, quantizer step size, motion vector information specifying the manner in which the macrobock was motion compensated, etc.) form a compressed bitstream of an encoded macroblock. The encoded macroblock may be passed to a Network Abstraction Layer (NAL) for transmission and/or storage.

In order to effectuate INTRA mode coding, the negative input of difference block 78 is connected to an INTRA mode block (via selector 71). In INTRA mode a prediction macroblock is formed from samples in the incoming video frame Fₙ that have been previously encoded and reconstructed (but un-filtered by filter 76). The prediction block generated in INTRA mode may be subtracted from the best match of a macroblock in the currently incoming video frame Fₙ to produce a residual or difference macroblock D′ₙ. The difference macroblock D′ₙ is transformed and quantized by transformation block 82 and quantize block 84 to provide a set of quantized transform coefficients. These coefficients may be entropy encoded by entropy encode block 86. The entropy encoded coefficients together with residual data required to decode the macroblock form a compressed bitstream of an encoded macroblock which may be passed to a Network Abstraction Layer (NAL) for transmission and/or storage.

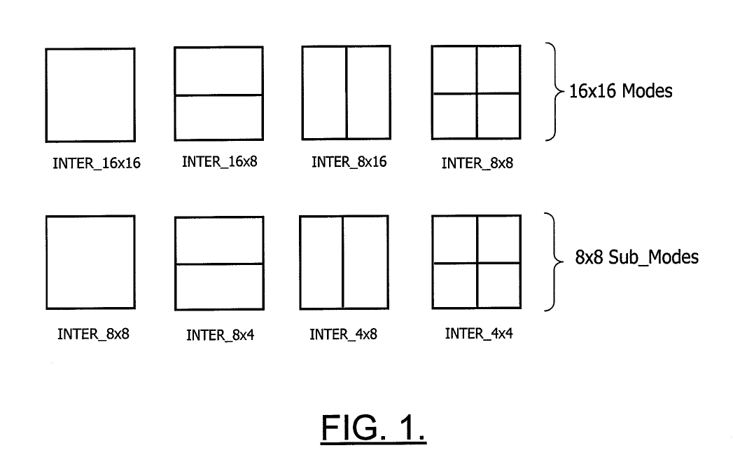

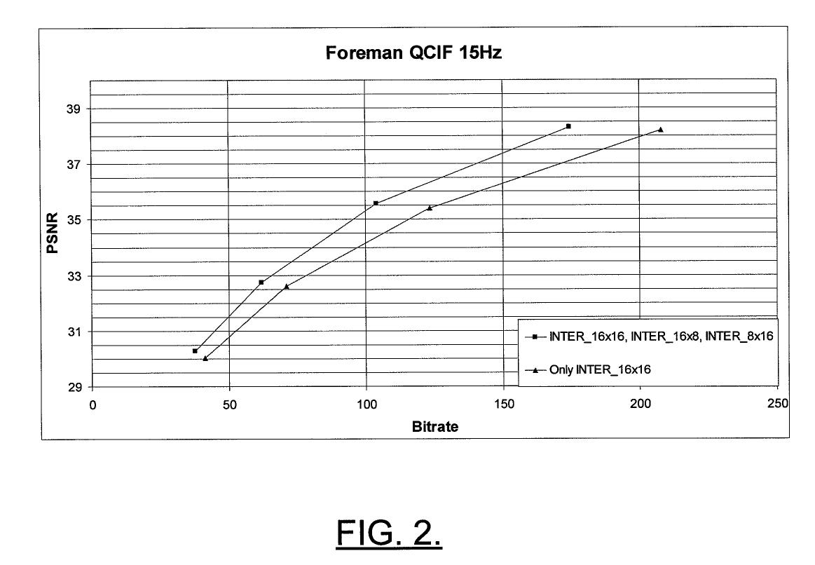

As will be appreciated by those skilled in the art, H.264/AVC supports two block types (sizes) for INTRA coding, namely, 4×4 and 16×16. The 4×4 INTRA block supports 9 prediction modes. The 16×16 INTRA block supports 4 prediction modes. It should also be pointed out that H.264/AVC supports a SKIP mode in the INTER coding mode. H.264/AVC utilizes a tree structured motion compensation of various block sizes and partitions in INTER mode coding. As discussed above, H.264/AVC allows INTER coded macroblocks to be sub-divided in partitions and range in sizes such as 16×16, 16×8, 8×16 and 8×8. The INTER coded macroblocks may herein be referred to as INTER modes such as INTER_{—}16×16, INTER_{—}16×8, INTER_{—}8×16 and INTER_{—}8×8 modes, in which the INTER_{—}16×16 mode has a 16×16 block size, the INTER_{—}16×8 mode has a 16×8 partition, the INTER_{—}8×16 mode has a 8×16 partition and the INTER_{—}8×8 mode has 8×8 partitions. (See e.g., FIG. 1) Additionally, H.264/AVC supports sub-macroblocks having sub-partitions ranging in block sizes such as 8×8, 8×4, 4×8 and 4×4. The INTER coded sub-macroblocks may herein be referred to as INTER sub-modes such as INTER_{—}8×8, INTER_{—}8×4, INTER_{—}4×8 and INTER_{—}4×4 sub-modes. (See e.g., FIG. 1) These partitions and sub-partitions give rise to a large number of possible combinations within each macroblock. As explained in the background section, a separate motion vector is typically transmitted for each partition or sub-partition of a macroblock and motion estimation is typically performed each partition. This increasing number of motion estimation operations drastically increases the complexity of a conventional H.264/AVC encoder.

The fast INTER mode decision algorithm of embodiments of the present invention decreases much of the complexity associated with a conventional H.264 encoder by reducing the number of motion estimation operations without a significant decrease in coding efficiency. The encoder 68 can determine the manner in which to divide the macroblock into partitions and sub-macroblock partitions based on the qualities of a particular macroblock in order to maximize a cost function as well as to maximize compression efficiency. The cost function is a cost comparison by the encoder 68 in which the encoder 68 decides whether to encode a particular macroblock in either the INTER or INTRA mode. The mode with the minimum cost function is chosen as the best mode by the encoder 68. According to an exemplary embodiment of the present invention, the cost function is given by J(MODE)|QP=SAD+λ_{MODE}. R(MODE) where QP is the quantization parameter, SAD is the Sum of Absolute Differences between predicted and original macroblock and R(MODE) is the number of syntax bits used for the given mode (e.g., INTER or INTRA) and λ_{MODE} is the Lagrangian parameter to balance the tradeoff between distortion and number of bits.

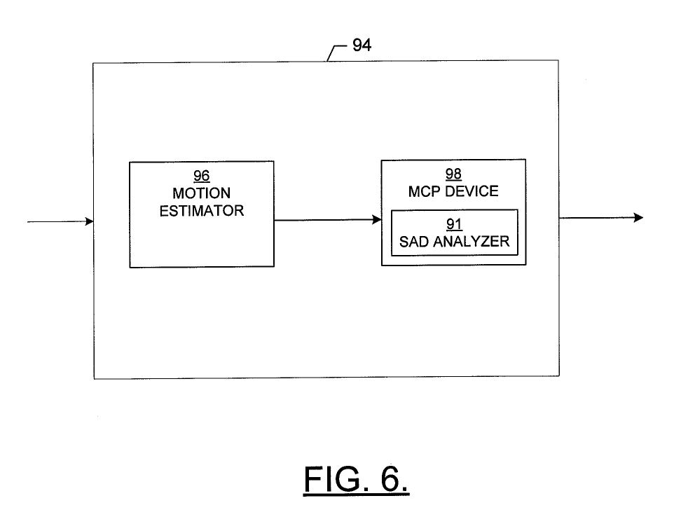

Referring now to FIG. 6, a block diagram of a motion compensated prediction module 94 according to an exemplary embodiment of the invention is shown. The motion compensated prediction module 94 may be a component of the encoder 68. The motion compensated prediction module 94 includes a motion estimator 96 which may be the motion estimation block 70 of FIG. 5. Additionally, the motion compensated prediction module 94 includes a motion compensated prediction device 98 which may be the motion compensated prediction block 72 of FIG. 5. The motion compensated prediction (MCP) device 98 includes a Sum of Absolute Differences (SAD) analyzer 91. The motion compensated prediction module 94 may be any device or means embodied in either hardware, software, or a combination of hardware and software that is capable of performing motion compensated prediction on a variable size macroblock which may have partitions and sub-partitions. The motion compensated prediction module 94 may operate under control of a processing element such as controller 20 or a coprocessor which may be an element of the video module 36.

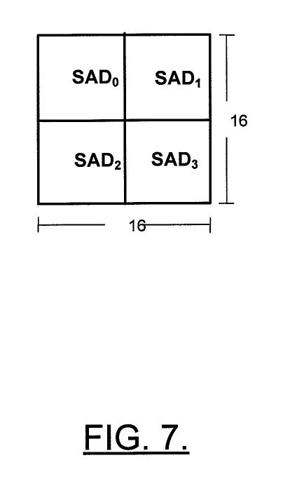

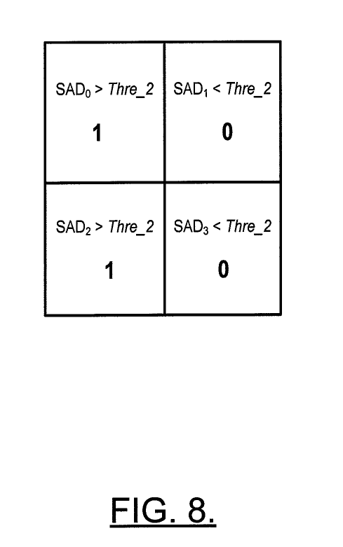

In an exemplary embodiment, the motion compensated prediction module 94 may analyze variable sized-macroblocks corresponding to a segment of a current video frame such as frame Fₙ. For instance, the motion compensated prediction module 94 may analyze a 16×16 sized macroblock having one or more partitions (See e.g., INTER_{—}16×8, INTER_{—}8×16 and INTER_{—}8×8 modes of FIG. 1). A motion vector corresponding to a 16×16 macroblock (referred to herein as an “original macroblock”) of the current video frame Fₙ may be extracted from the 16×16 macroblock by the motion estimator 96. The motion vector is transmitted to a motion compensated prediction device 98 and the motion compensated prediction device 98 uses the motion vector to generate a predicted macroblock by shifting a corresponding macroblock in a previously encoded reference frame (e.g., frame F′ₙ₋₁) that may be stored in a memory, such as reference frame memory 74. The motion compensated prediction device 98 includes a SAD analyzer 91 which determines the difference (or error) between the original macroblock and the predicted macroblock by analyzing one or more regions of the predicted 16×16 macroblock. Particularly, the SAD analyzer of one embodiment evaluates 8×8 blocks of a 16×16 macroblock to determine the Sum of Absolute Differences (SAD) (or error or for example, a distortion value) of four regions within the predicted 16×16 macroblock, namely SAD₀, SAD₁, SAD₂ and SAD₃, as shown in FIG. 7. The SAD analyzer 91 compares each of the four regions (SAD₀, SAD₁, SAD₂ and SAD₃) to a predetermined threshold such as Thre_2. By evaluating the four regions, the SAD analyzer 91 is able to analyze the locality and energy of the distortion between the original and predicted macroblocks. When the SAD is less than the predetermined threshold Thre_2 for a given region of the predicted 16×16 macroblock, the SAD analyzer determines that the prediction results for the given region were sufficiently accurate and assigns a binary bit 0 to the region in a Binary SAD Map. (See e.g., SAD₁ in the Binary SAD Map of FIG. 8) On the other hand, when the SAD analyzer, determines that the prediction results for a given region of the predicted 16×16 macroblock exceeds the predetermined threshold Thre_2, the SAD analyzer decides that the results for the particular region of the predicted 16×16 macroblock are not as accurate as desired and assigns a binary bit 1 to the region in the Binary SAD Map. (See e.g., SAD₀ in the Binary SAD Map of FIG. 8).

Referring to FIG. 8, an example of a Binary SAD Map, generated by SAD analyzer, having a binary value of 1010 is illustrated. As shown in FIG. 8, the SAD analyzer determined that the prediction results for regions SAD₀ and SAD₂ exceeded predetermined threshold Thre_2 and assigned binary bit 1 to each region indicating that the prediction results for these regions of the predicted 16×16 macroblock were not as accurate as desired. The SAD analyzer also determined that the prediction results for regions SAD₁ and SAD₃ were less than predetermined threshold Thre_2 and assigned binary bit 0 to these regions indicating that the prediction results for these regions in the predicted 16×16 macroblock are sufficiently accurate.

Based on the results of the Binary SAD Map generated by the SAD analyzer, the motion compensated prediction device 98 determines whether certain regions of a 16×16 macroblock need to be evaluated. As discussed above in the background section, conventionally a motion vector is extracted for each partition of a 16×16 macroblock. This is not necessarily the case with respect to the exemplary embodiments of the present invention. For sake of example, consider an original macroblock such as a 16×16 block sized macroblock having a 16×8 partition (i.e., INTER_{—}16×8 mode; See e.g., FIG. 1) in a current video frame Fₙ. The motion estimator 96, first extracts a motion vector from a corresponding segment of the 16×16 macroblock which has a 16×8 partition, (i.e., INTER_{—}16×8 mode of FIG. 1) of current video frame Fₙ. The motion vector is initially extracted by the motion estimator 96 as if the 16×16 macroblock had no 16×8 partition (e.g., as if the 16×16 macroblock corresponds to the INTER_{—}16×16 mode; See e.g., FIG. 1). In other words, the motion vector is initially extracted as without regards to the 16×8 partition. As such, motion vectors corresponding to the upper and lower partitions of the INTER_{—}16×8 mode block are not initially extracted by the motion estimator 96. The motion compensated prediction device 98 generates a prediction macroblock by shifting a matching macroblock in a reference frame in the manner discussed above.

Once the predicted macroblock is generated, the SAD analyzer evaluates each region of the predicted 16×16 macroblock and generates a Binary SAD Map in the manner described above. If the SAD analyzer determines that the results are sufficiently accurate for each region, the motion compensated prediction module 94 determines that motion vectors of the upper and lower partitions of the INTER_{—}16×8 mode block need not be extracted. In other words, the upper and lower partitions are not evaluated and hence motion estimation is not performed with respect to the upper and lower partitions. For instance, if the SAD analyzer determines that the prediction results for regions SAD₀, SAD₁, SAD₂ and SAD₃ are each below predetermined threshold Thre_2, binary bit 0 is assigned to each region and the Binary SAD Map generated by SAD analyzer has a binary value of 0000, which indicates that the prediction results for each region are sufficiently accurate. In this regard, the motion compensated prediction module 94 determines that motion estimation need not be performed for the upper and lower partitions of the INTER_{—}16×8 mode block and simply uses the motion vector corresponding to a 16×16 mode block (i.e., INTER_{—}16×16 mode; See e.g., FIG. 1) to perform motion estimation, motion compensated predication and to generate a predicted macroblock. As such, the number of motion estimation computations at the encoder 68 is reduced without suffering a significant decrease in coding efficiency.

If the SAD analyzer generated a binary value of 1010 in the Binary SAD Map (instead of binary value 0000 in the above example), indicating that the prediction results of regions SAD₀ and SAD₂ exceeded predetermined threshold Thre_2 and that the prediction results for regions SAD₁ and SAD₃ were less than predetermined threshold Thre_2, the SAD analyzer determines that the prediction results for the left partition of the INTER_{—}8×16 mode block is not as accurate as desired while the prediction results of the right partition are sufficiently accurate. As such, the motion estimator 96 extracts a second motion vector from the original 16×16 macroblock, having an 8×16 partition (INTER_{—}16×8 mode), of current video frame Fₙ. The second motion vector is extracted from the left partition of the INTER_{—}8×16 mode block. Motion estimator 96 performs motion estimation so that motion compensated prediction can be performed on the left partition by the motion compensated prediction device 98. However, since the Binary SAD Map indicates that the results of regions SAD₁ and SAD₃ are sufficiently accurate, a motion vector from the right partition need not be extracted and hence motion estimation and motion compensation for the right partition of the INTER_{—}8×16 mode block need not be performed thereby reducing the number of motion estimation operations at the encoder 68. Thereafter, the motion compensated prediction module 94 may choose the best coding mode between the best INTER modes (i.e., among the INTER_{—}16×16 mode and the left partition of the INTER_{—}8×16 mode in this example) and the best INTRA mode. In one embodiment, the best coding mode is the one minimizing a cost function according to the equation J(MODE)|QP=SAD+λ_{MODE}. R(MODE).

Consider another example, in which the SAD analyzer generated a Binary SAD Map having a binary value 0101. The SAD analyzer determines that the prediction results of regions SAD₀ and SAD₂ are below predetermined threshold Thre_2 and that the prediction results of the left partition of the INTER_{—}8×16 mode block are sufficiently accurate whereas the prediction results of the regions SAD₁ and SAD₃ are above predetermined threshold Thre_2 indicating that the prediction results for the right partition of the INTER_{—}8×16 mode block are not as accurate as desired. As such, the motion estimator 96 extracts a first motion vector based on the 16×16 INTER_mode in the manner discussed above, and subsequently extracts another motion vector (i.e., a second motion vector) from the right partition of the INTER_{—}8×16 mode block so that motion estimation and motion compensated prediction for the right partition is preformed. However, since the results for SAD₀ and SAD₂ are sufficiently accurate, a motion vector need not be extracted corresponding to the left partition of the INTER_{—}8×16 mode block. In other words, the left partition is not evaluated. Thereafter, the motion compensated prediction module 94 may choose the best coding mode between the best INTER modes (i.e., among the INTER_{—}16×16 mode and the right partition of the INTER_{—}8×16 mode in this example) and the best INTRA mode. As stated above, the best coding mode of one embodiment is the one minimizing a cost function.

Suppose instead that motion estimator 96 evaluates an original 16×16 sized macroblock having an 16×8 partition (i.e., INTER_{—}16×8 mode; See e.g., FIG. 1) of current frame Fₙ. In this regard, the motion estimator 96 first extracts a motion vector as if the 16×16 sized macroblock is an INTER_{—}16×16 mode block, that is to say, without regards to the upper and lower partitions of the INTER_{—}16×8 mode block. Consider an example in which SAD analyzer generated a Binary SAD Map having a binary value 0011. In this regard, the SAD analyzer determines that SAD₀ and SAD₁ are less than predetermined threshold Thre_2 while SAD₂ and SAD₃ exceed predetermined threshold Thre_2. This means that the results for SAD₀ and SAD₁ are sufficiently accurate whereas the results for SAD₂ and SAD₃ are not as accurate as desired. As such, motion estimator extracts a second motion vector from the INTER_{—}16×8 mode block corresponding to the lower partition and performs motion estimation so that motion compensated prediction can be performed on the lower partition. However, since the results for SAD₀ and SAD₁ are very accurate, a motion vector corresponding to the upper partition of the INTER_{—}16×8 mode block need not be extracted and hence motion estimation and motion compensated prediction need not be performed for the upper partition.

As such, the number of motion estimation operations at the encoder 68 is reduced. Subsequently, the motion compensated prediction module 94 may choose the best coding mode between the best INTER modes (i.e., among the INTER_{—}16×16 mode and the lower partition of the INTER_{—}16×8 mode in this example) and the best INTRA mode. The best coding mode may be the one minimizing a cost function, as described above.

Consider an example in which the SAD analyzer generated a Binary SAD Map having a binary value 1100 when the motion estimator 96 evaluates an original 16×16 sized macroblock having an 16×8 partition (i.e., INTER_{—}8×16 mode; See e.g., FIG. 1) of current frame Fₙ. In this regard, the SAD analyzer determines that SAD₀ and SAD₁ exceed predetermined threshold Thre_2 while SAD₂ and SAD₃ are less than predetermined threshold Thre_2. This means that the results for SAD₀ and SAD₁ are not as accurate as desired whereas the results for SAD₂ and SAD₃ are sufficiently accurate. As such, motion estimator 96 extracts a second motion vector from the INTER_{—}16×8 mode block corresponding to the upper partition and performs motion estimation so that motion compensated prediction can be performed on the upper partition. However, since the results for SAD₂ and SAD₃ are sufficiently accurate, a motion vector corresponding to the lower partition of the INTER_{—}16×8 mode block need not be extracted and hence motion estimation and motion compensated prediction need not be performed for the lower partition.

In this regard, the complexity of the encoder 68 is reduced since the number of motion estimation operations is reduced. Subsequently, the motion compensated prediction module 94 may choose the best coding mode between the best INTER modes (i.e., among the INTER_{—}16×16 mode and the upper partition of the INTER_{—}16×8 mode in this example) and the best INTRA mode. The best coding mode may be the one minimizing a cost function.

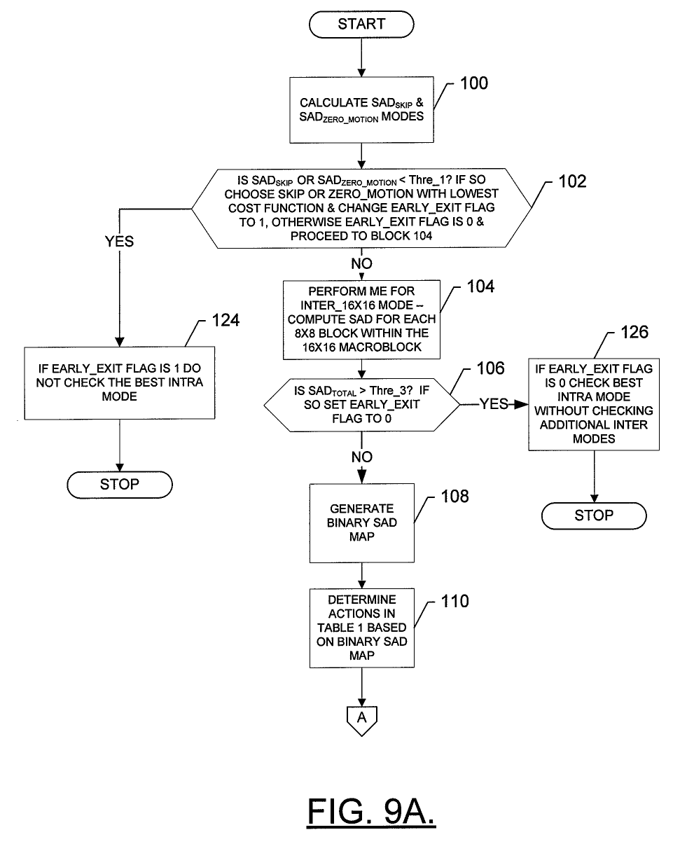

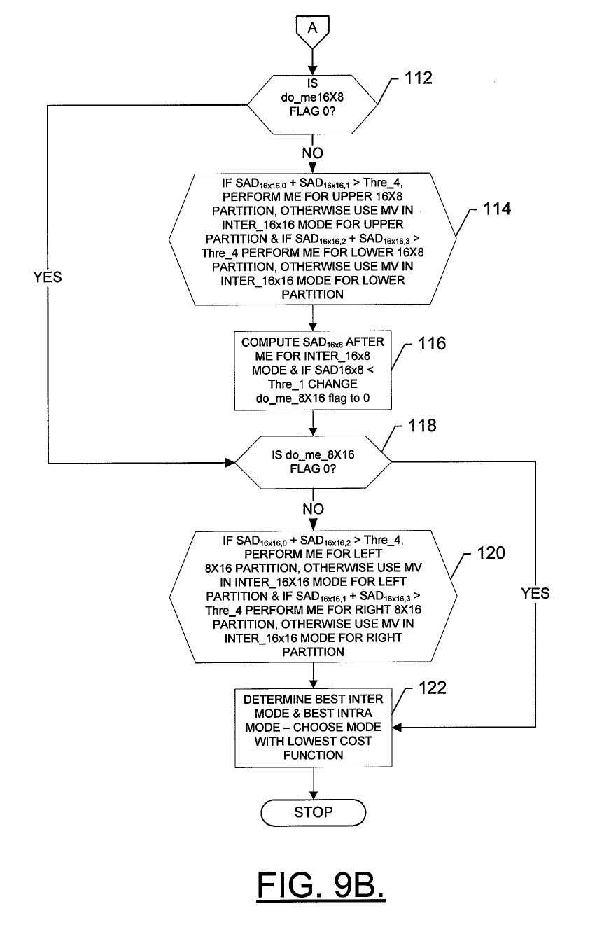

FIGS. 9A and 9B are flowcharts of a method and program product of generating a fast INTER mode decision algorithm according to exemplary embodiments of the invention. The fast INTER mode decision algorithm may be implemented by the encoder 68 of FIG. 5 which is capable of operating under control of a processing element such as controller 20 or a coprocessor which may be an element of the video module 36. As such, the flowcharts include a number of steps, the functions of which may be performed by a processing element such as controller 20, or a coprocessor for example. It should be understood that the steps may be implemented by various means, such as hardware and/or firmware. In such instances, the hardware and/or firmware may implement respective steps alone and/or under control of one or more computer program products. In this regard, such computer program product(s) can include at least one computer-readable program code portions, such as a series of computer instructions, embodied in the computer-readable storage medium.

The processing element may receive an incoming video frame (e.g., Fₙ) and may analyze variable sized 16×16 macroblocks which may have a number of modes (e.g., INTER_{—}16×16, INTER_{—}16×8, INTER_{—}8×16 and INTER_{—}8×8) that are segmented within the video frame. The processing element may extract a motion vector from a 16×16 macroblock (referred to herein as “original macroblock”) of the video frame and perform motion estimation and motion compensated prediction to generate a prediction macroblock. Further, the processing element may compare the Sum of Absolute Differences (SAD) between the prediction macroblock and the original macroblock. For instance, to implement the fast INTER mode decision algorithm of the exemplary embodiments of the invention, the processing element calculates the SAD for SKIP mode and ZERO_MOTION modes. That is to say, the processing element calculates SAD_{SKIP} and SAD_{ZERO}_{_{—}}_{MOT}, respectively, as known to those skilled in the art. See block 100. As defined herein, the ZERO_MOTION mode refers to an INTER_{—}16×16 mode in which the extracted motion vector is equal to (0,0) which signifies that there is no motion or very little motion between the original macroblock and the prediction macroblock. As defined in the H.264/AVC standard, in the SKIP mode an encoder (e.g. encoder 68) does not send any motion vector and residual data to a decoder, and the decoder only uses the predicted motion vector to reconstruct the macroblock. If the predicted motion vector is (0,0), prediction generated for the SKIP mode would be identical to that of ZERO_MOTION mode. (This is because, in H.264/AVC, every motion vector in a macroblock is coded predictively. That is to say, a prediction for the motion vector is formed using motion vectors in previous macroblocks but in the same frame. This prediction motion vector could be have a value of (0,0), or some other value(s). If a macroblock is coded in SKIP mode, no motion vector is sent to the decoder, as known to those skilled in the art, and the decoder assumes the motion vector for the macroblock is the same as the predicted motion vector. As such, if the prediction motion vector is (0,0), then ZERO_MOTION will be identical to the SKIP mode.) If the processing element determines that SAD_{SKIP} is less than a predetermined threshold Thre_1 or that SAD_{ZERO}_{_{—}}_{MOT} is less than predetermined threshold Thre_1, the processing element chooses between the SKIP or ZERO_MOTION modes based on the mode that provides the smallest cost function and does not further evaluate INTRA mode. The processing element then changes an early_exit flag to 1 (which signifies either the SKIP or the ZERO_MOTION modes provide sufficiently accurate prediction results). See blocks 102 and 124. Otherwise, the processing element changes the early exit flag to 0 (which signifies that the SKIP and ZERO_MOTION modes did not provide prediction results with the accuracy desired). See block 102. The processing element then performs motion estimation (ME) for the INTER_{—}16×16 mode and calculates the SAD for each 8×8 block within the 16×16 macroblock resulting in four SAD values corresponding to regions SAD_{16×16,0}, SAD_{16×16,1}, SAD_{16×16,2}, and SAD_{16×16,3} of the 16×16 macroblock. See block 104; See also, e.g., FIG. 7.

Subsequently, the processing element determines whether SAD_{TOTAL}=SAD_{16×16,0}+SAD_{16×16,1}+SAD_{16×16,2}+SAD_{16×16,3} is greater than a predetermined threshold Thre_3 and if so, the processing element changes early_exit flag to 0 and determines the best INTRA mode (determined as known to those skilled in the art) without evaluating additional INTER modes. See blocks 106 and 126. In other words, when the total (SAD_{TOTAL}) of SAD_{16×16,0}+SAD_{16×16,1}+SAD_{16×16,2}+SAD_{16×16,3} is greater than predetermined threshold Thre_3 after motion estimation is performed for the INTER_{—}16×16 mode block, the processing element determines that the error between the original and predicted macroblocks is large for partitions of the 16×16 macroblock (i.e., the error is large for other INTER modes of the 16×16 mode macroblock, such as, for example, INTER_{—}16×8, INTER_{—}8×16 and INTER_{—}8×8 modes). As such, the processing element decides not to expend time and resources determining additional INTER modes and instead determines the best INTRA mode.

If SAD_{TOTAL} does not exceed predetermined Thre_3, the processing element then generates a Binary SAD Map comprising four bits corresponding to four SAD regions, namely SAD₀, SAD₁, SAD₂ and SAD₃. See block 108. Each bit corresponds to the result of a comparison between a SAD value of the region and a predetermined threshold Thre_2. If the SAD value is less than predetermined threshold Thre_2, the processing element assigns binary bit 0 to the corresponding SAD region in the Binary SAD Map (See e.g., SAD₁ of FIG. 8). On the other hand, if the SAD value exceeds predetermined threshold Thre_2, the processing element assigns binary bit 1 to the corresponding SAD region in the Binary SAD Map (See e.g., SAD₀ of FIG. 8).

Depending on the Binary SAD Map generated by the processing element, the processing element determines one of the following actions set forth in Table 1 below. See block 110.

TABLE 1

| BINARY | |
|---|---|
| SAD MAP | ACTION |
| 0000 | Change do_me_16x8 flag to 0, do_me_8x16 flag to 0 |
| 0011 | Change do_me_16x8 flag to 1, do_me_8x16 flag to 0. |
| 1100 | Change do_me_16x8 flag to 1, do_me_8x16 flag to 0. |
| 1010 | Change do_me_16x8 flag to 0, do_me_8x16 flag to 1. |
| 0101 | Change do_me_16x8 flag to 0, do_me_8x16 flag to 1. |
| Else | Change do_me_16x8 flag to 1, do_me_8x16 flag to 1. |

If the processing element determines that do_me_{—}16×8 flag is 0 for a given binary value in the Binary SAD Map (e.g., binary value 0000), the processing element then decides whether do_me_{—}8×16 flag is 0 for the corresponding binary value and if so, the processing element determines the best INTER mode, among the INTER modes in which motion estimation was previously performed, and the best INTRA mode and chooses between the best INTER mode and the best INTRA mode based on the mode which minimizes a cost function, such as that given by J(MODE)|QP=SAD+λ_{MODE}. R(MODE). See blocks 112, 118 and 122. Otherwise, the processing element determines whether SAD_{16×16,0}+SAD_{16×16,1} is greater than a predetermined threshold Thre_4 and if so, the processing element performs motion estimation for a upper partition of a 16×8 macroblock partition (See e.g., INTER_{—}16×8 mode of FIG. 1). Otherwise, the processing element uses the motion vector (MV) found in the INTER_{—}16×16 mode (determined in block 104) as the motion vector for the upper partition. In like manner, the processing element determines whether SAD_{16×16,2}+SAD_{16×16,3} exceeds predetermined threshold Thre_4, and if so, the processing element performs motion estimation for the lower partition of the 16×8 macroblock partition. Otherwise, the processing element uses the motion vector found in INTER_{—}16×16 mode (determined in block 104) as the motion vector for the lower partition. See block 114.

The processing element then computes SAD_{16×8} after the motion estimation process for INTER_{—}16×8 mode (i.e., the 16×8 macroblock partition) and if SAD_{16×8} is below predetermined threshold Thre_1, the processing element changes do_me_{—}8×16 flag to 0. See block 116. If do_me_{—}8×16 flag is 0, the processing element, determines the best INTER mode, among the INTER modes in which motion estimation was previously performed, and the best INTRA mode and chooses between the best INTER mode and the best INTRA mode based on the mode which has the lowest cost function. See blocks 118 and 122.

Thereafter, the processing element decides whether SAD_{16×16,0}+SAD_{16×16,2} is greater than predetermined threshold Thre_4 and if so, the processing element performs motion estimation for a left partition of an 8×16 macroblock partition. See e.g., INTER_{—}8×16 mode of FIG. 1. Otherwise, the processing element utilizes the motion vector found in INTER_{—}16×16 mode (determined in block 104) as the motion vector for the left partition of the 8×16 macroblock partition. Similarly, the processing element determines whether SAD_{16×16,1}+SAD_{16×16,3} is greater than predetermined threshold Thre_4 and if so, the processing element performs motion estimation for the right partition of the 8×16 macroblock partition. Otherwise, the processing element utilizes the motion vector found in INTER_{—}16×16 mode (determined in block 104) as the motion vector for the right partition. See block 120.

Subsequently, the processing element, determines the best INTER mode, among the INTER modes in which motion estimation was previously performed, and the best INTRA mode and chooses between the best INTER mode and the best INTRA mode based on the mode which has the lowest cost function. See block 122.

In the exemplary embodiments of the present invention, the predetermined thresholds Thre_1, Thre_2, Thre_3 and Thre_4 are dependent on a quantization parameter (QP) with a piecewise linear function. The dependency of the predetermined threshold values (Thre_1, Thre_2, Thre_3 and Thre_4) on QP can be shown in the equations below. Th_unit(QP) is used to adapt the thresholds according to quantization parameter. The parameter skipMultiple is a pre-defined constant and is used to determine the early-exit threshold for SKIP and ZERO_MOTION modes. The parameters sadMultiple1 and sadMultiple2 are pre-defined constants and are used in exemplary embodiments as described above. The parameter exitToIntraTh is a pre-defined constant and is used in deciding whether to early exit to INTRA mode.

$$Th\_unit ( QP ) = \{ \begin{matrix}10. ( QP - 21 ) , & if QP > 30 \\ 5. ( QP - 12 ) , & otherwise\end{matrix} \\ Thre\_ 1 ( QP ) = skipMultiple . Th\_unit ( QP ) \\ Thre\_ 2 ( QP ) = sadMultiple1 . Th\_unit ( QP ) \\ Thre\_ 3 = exitToIntraTh \\ Thre\_ 4 ( QP ) = sadMultiple2 . Th\_unit ( QP )$$

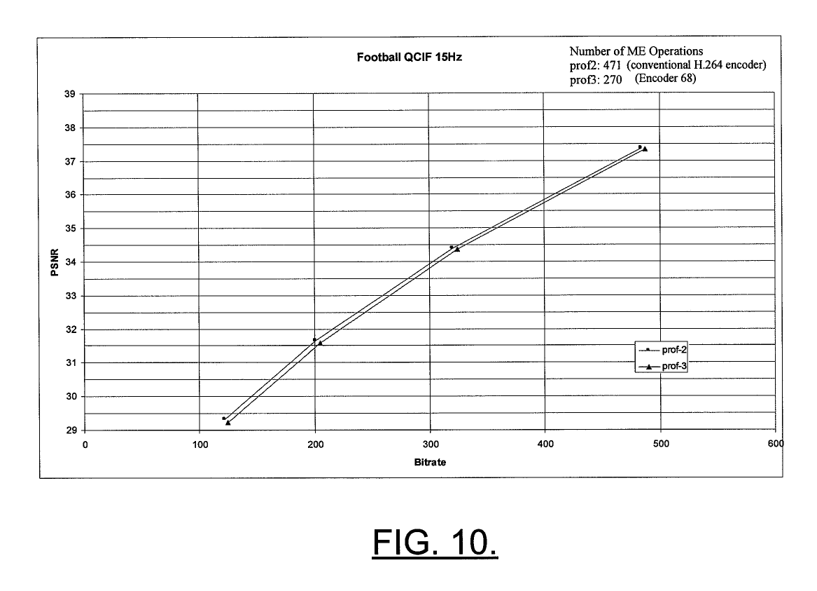

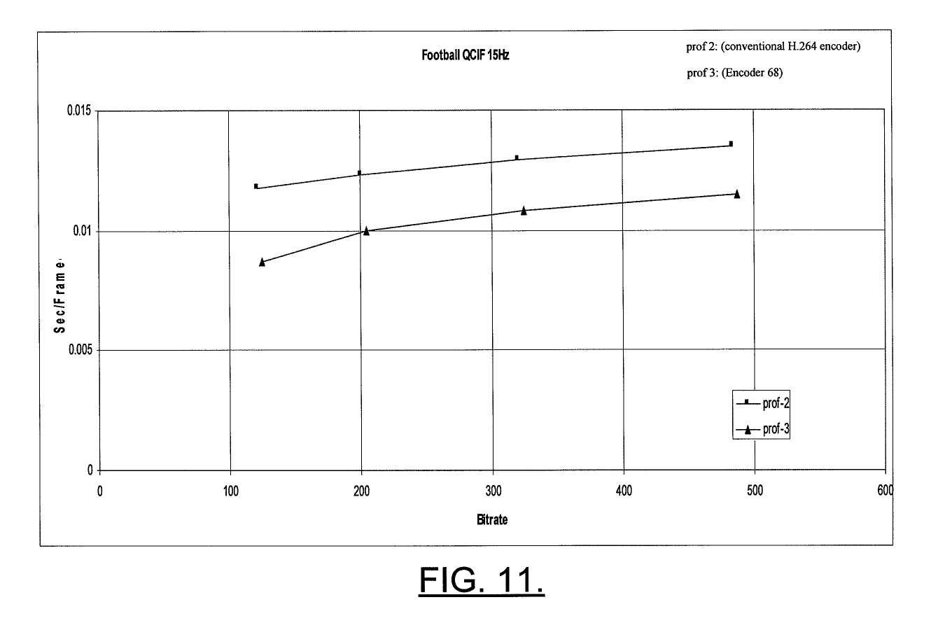

Referring now to FIG. 10, a graphical representation of the average complexity reduction achieved by the encoder of the exemplary embodiments of the present invention is illustrated. With respect to FIG. 10, prof3 corresponds to the encoder of the exemplary embodiments (e.g. encoder 68) of the present invention whereas prof2 corresponds to the conventional H.264 encoder. As shown in FIG. 10, the number of motion estimation operations for the encoder of the present invention, which utilizes the fast INTER mode decision algorithm described above, was 270 as opposed to 471 for the conventional H.264 encoder for a given video sequence (i.e., a video sequence relating to football encoded in QCIF, 176×144 resolution in 15 frames-per-second) As shown, the encoder of the exemplary embodiments of the present invention also achieves a lower peak signal-to-noise ratio (PSNR) at a given bitrate than the conventional H.264 encoder. Turning now to FIG. 11, a graphical representation of the average complexity reduction achieved by an exemplary encoder of the present invention is shown in terms of bitrate versus seconds per frame (i.e., Sec/Frame). With regards to FIG. 11, prof3 corresponds to the encoder according to exemplary embodiments of the present invention whereas prof2 corresponds to the conventional H.264 encoder. As demonstrated in FIG. 11, the encoder of the exemplary embodiments of the present invention encodes a video frame faster at a given bitrate than the conventional H.264 encoder.

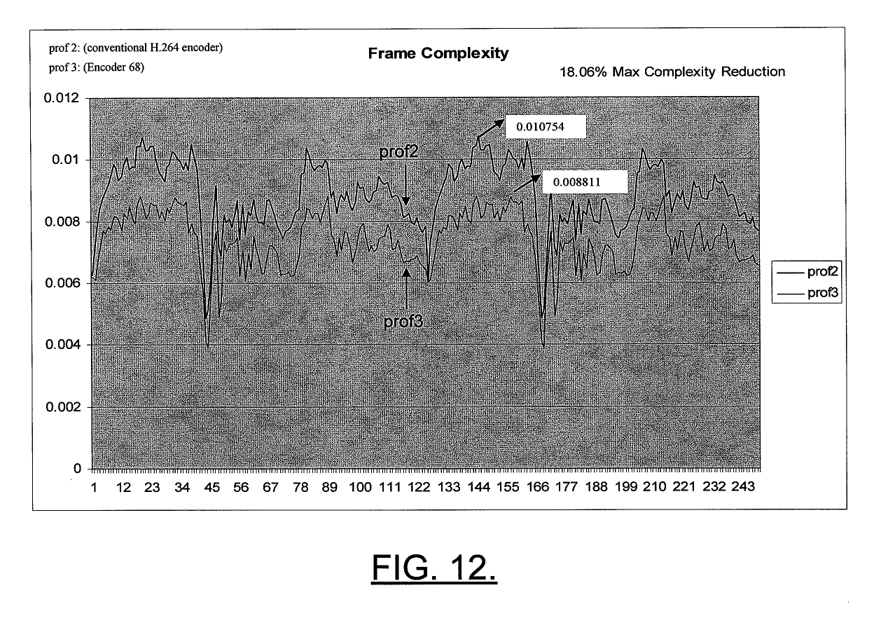

Referring to FIG. 12, a graphical representation relating to frame complexity (i.e., encoding complexity of a video frame) is illustrated. As referred to herein, frame complexity is the time used to encode one frame in a Pentium based personal computer (PC) measured in milliseconds. In FIG. 12, prof 3 corresponds to the encoder according to the exemplary embodiments of the present invention whereas prof2 corresponds to the conventional H.264 encoder. As illustrated in FIG. 12, for a given video frame, the encoder according to the exemplary embodiments of the present invention achieves an 18.06% maximum complexity reduction with respect to the conventional H.264 encoder.

It should be understood that each block or step of the flowcharts, shown in FIGS. 9A and 9B, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

For instance, while the fast INTER mode decision algorithm of the present invention has been described above with reference to macroblocks having 16×8 and 8×16 partitions, it should also be understood that the fast INTER mode decision algorithm could easily be extended to smaller partitions such as an 8×8 macroblock partition. Furthermore, the fast INTER mode decision algorithm of embodiments of the present invention could be extended to sub-macroblocks (e.g., an 8×8 block sized sub-macroblock) and sub-partitions such as 8×4, 4×8 and 4×4 without departing from the spirit and scope of the present invention. Additionally, while the fast INTER mode decision algorithm of embodiments of the present invention was hereinbefore explained in terms of the H.264/AVC video coding standard, it should be understood that the fast INTER mode decision algorithm is applicable to any video coding standard that supports variable sized block-sized motion estimation.

That which is claimed:

1. A method of selecting a mode for encoding a macroblock using motion compensated prediction, the method comprising:
extracting at least one motion vector from at least one macroblock of a video frame, the at least one macroblock comprising a first plurality of inter modes having a plurality of block sizes;
generating at least one prediction for the macroblock based on the at least one motion vector by analyzing a reference frame; and
comparing a distortion value to a first predetermined threshold and selecting a first encoding mode among first and second encoding modes without evaluating the second encoding mode based upon the comparison of the distortion value to the first predetermined threshold.

2. A method according to claim 1, wherein prior to the comparing a distortion value, comparing a residual error of the at least one macroblock to another predetermined threshold corresponding to a plurality of predetermined candidate motion vectors, and wherein the plurality of predetermined candidate motion vectors comprises a subset of a plurality of motion vectors.

3. A method according to claim 2, wherein the plurality of predetermined candidate motion vectors comprises at least one motion vector having a value of (0,0) in x and y directions, and a predicted motion vector having a value that is dependent on values of motion vectors corresponding to macroblocks in a frame.

4. A method according to claim 1, further comprising:
estimating the motion of the at least one macroblock based on the extracted motion vector when the at least one macroblock consists of a first block size among the plurality of block sizes; and
calculating a plurality of distortion values, each of the plurality of distortion values corresponding to a respective region of the at least one macroblock when the at least one macroblock consists of the first block size among the plurality of block sizes.

5. A method according to claim 4, further comprising:
summing the plurality of distortion values for the plurality of regions to generate a total; and
comparing the total to a second predetermined threshold and, when the total exceeds the second predetermined threshold, selecting the second coding mode, without evaluating the first coding mode.

6. A method according to claim 4, further comprising, generating a binary distortion map comprising a plurality of bits, wherein a value of each bit corresponds to a comparison with a third predetermined threshold and wherein each bit corresponds to a respective region of the at least one macroblock when the at least one macroblock consists of the first block size among the plurality of block sizes.

7. A method according to claim 4, further comprising:
determining whether the summation of a first distortion value and a second distortion value exceeds a fourth predetermined threshold, wherein the first distortion value and the second distortion value correspond to a first partition of the at least one macroblock when the at least one macroblock consists of a second block size among the plurality of block sizes;
estimating the motion corresponding to the first partition when the summation of the first distortion value and the second distortion value exceeds the fourth predetermined threshold; and
using the at least one motion vector extracted from the at least one macroblock, when the at least one macroblock consists of the first block size among the plurality of block sizes, as a motion vector corresponding to the first partition when the summation of the first distortion value and the second distortion value is less than the fourth predetermined threshold.

8. A method according to claim 7, further comprising:
determining whether the summation of a third distortion value and a fourth distortion value exceeds the fourth predetermined threshold, wherein the third distortion value and the fourth distortion value correspond to a second partition of the at least one macroblock when the at least one macroblock consists of the second block size among the plurality of block sizes;
estimating the motion corresponding to the second partition when the summation of the third distortion value and the fourth distortion value exceeds the fourth predetermined threshold; and
using the at least one motion vector extracted from the at least one macroblock, when the at least one macroblock consists of the first block size among the plurality of block sizes, as a motion vector corresponding to the second partition when the summation of the third distortion value and the fourth distortion value is less than the fourth predetermined threshold.

9. A method according to claim 7, further comprising:
determining whether the summation of a fifth distortion value and a sixth distortion value exceeds the fourth predetermined threshold, wherein the fifth distortion value and the sixth distortion value correspond to a third partition of the at least one macroblock when the at least one macroblock consists of a third block size among the plurality of block sizes;
estimating the motion corresponding to the third partition when the summation of the fourth distortion value and the fifth distortion value exceeds the fourth predetermined threshold; and
using the at least one motion vector extracted from the at least one macroblock, when the at least one macroblock consists of the first block size among the plurality of block sizes, as a motion vector corresponding to the third partition when the summation of the fifth distortion value and the sixth distortion value is less than the fourth predetermined threshold.

10. A method according to claim 9, further comprising:
determining whether the summation of a sixth distortion value and a seventh distortion value exceeds the fourth predetermined threshold, wherein the sixth distortion value and the seventh distortion value corresponds to a fourth partition of the at least one macroblock when the at least one macroblock consists of the third block size among the plurality of block sizes;
estimating the motion corresponding to the fourth partition when the summation of the sixth distortion value and the seventh distortion value exceeds the fourth predetermined threshold; and
using the at least one motion vector extracted from the at least one macroblock, when the at least one macroblock consists of the first block size among the plurality of block sizes, as a motion vector corresponding to the fourth partition when the summation of the sixth distortion value and the seventh distortion value is less than the fourth predetermined threshold.

11. A method according to claim 10, further comprising:
determining a best inter mode among the first, second and third block sizes in which motion estimation is performed;
determining a best intra mode among candidate intra modes; and
choosing the one of the best inter mode and the best intra mode which has a lowest cost function.

12. A method according to claim 1, wherein the first encoding mode comprises an inter coding mode based on temporal redundancy and the second encoding mode comprises an intra coding mode based on spatial redundancy.

13. A method according to claim 10, wherein the first block size is larger than the second and third block sizes and wherein the second block size comprises a horizontal partition and wherein the third block size comprises a vertical partition.

14. A computer program product for performing motion compensated prediction, the computer program product comprising at least one computer-readable storage medium having computer-readable program code portions stored therein, the computer-readable program code portions comprising:
a first executable portion for extracting at least one motion vector from at least one macroblock of a video frame, the at least one macroblock comprising a first plurality of inter modes having a plurality of block sizes;
a second executable portion for generating at least one prediction for the at least one macroblock based on the at least one motion vector by analyzing a reference frame; and
a third executable portion for comparing a distortion value to a first predetermined threshold and selecting a first encoding mode among first and second encoding modes without evaluating the second encoding mode based upon the comparison of the distortion value to the first predetermined threshold.

15. A computer program product according to claim 14, further comprising:
a sixth executable portion for estimating the motion of the at least one macroblock based on the extracted motion vector when the at least one macroblock consists of a first block size among the plurality of block sizes; and
a seventh executable portion for calculating a plurality of SAD values, each of the plurality of distortion values corresponding to a respective region of the at least one macroblock when the at least one macroblock consists of the first block size among the plurality of block sizes.

16. A computer program product according to claim 15, further comprising:
an eighth executable portion for summing the plurality of distortion values for the plurality of regions to generate a total; and
a ninth executable portion for comparing the total to a second predetermined threshold and, when the total exceeds the second predetermined threshold, selecting the second coding mode, without evaluating the first coding mode.

17. A computer program product according to claim 15, further comprising, a tenth executable portion for generating a binary distortion map comprising a plurality of bits, wherein a value of each bit corresponds to a comparison with a third predetermined threshold and wherein each bit corresponds to a respective region of the at least one prediction macroblock when the at least one macroblock consists of the first block size among the plurality of block sizes.

18. A computer program product according to claim 15, further comprising:
an eleventh executable portion for determining whether the summation of a first distortion value and a second distortion value exceeds a fourth predetermined threshold, wherein the first distortion value and the second distortion value correspond to a first partition of the at least one macroblock when the at least one macroblock consists of a second block size among the plurality of block sizes;
a twelfth executable portion for estimating the motion corresponding to the first partition when the summation of the first distortion value and the second distortion value exceeds the fourth predetermined threshold; and
a thirteenth executable portion for using the at least one motion vector extracted from the at least one macroblock, when the at least one macroblock consists of the first block size among the plurality of block sizes, as a motion vector corresponding to the first partition when the summation of the first distortion value and the second distortion value is less than the fourth predetermined threshold.

19. A computer program product according to claim 18, further comprising:
a fourteenth executable portion for determining whether the summation of a third distortion value and a fourth distortion value exceeds the fourth predetermined threshold, wherein the third distortion value and the fourth distortion value correspond to a second partition of the at least one macroblock when the at least one macroblock consists of the second block size among the plurality of block sizes;
a fifteenth executable portion for estimating the motion corresponding to the second partition when the summation of the third distortion value and the fourth distortion value exceeds the fourth predetermined threshold; and
a sixteenth executable portion for using the at least one motion vector extracted from the at least one macroblock, when the at least one macroblock consists of the first block size among the plurality of block sizes, as a motion vector corresponding to the second partition when the summation of the third distortion value and the fourth distortion value is less than the fourth predetermined threshold.

20. A computer program product according to claim 18, further comprising:
a seventeenth executable portion for determining whether the summation of a fifth distortion value and a sixth distortion value exceeds the fourth predetermined threshold, wherein the fifth distortion value and the sixth distortion value correspond to a third partition of the at least one macroblock when the at least one macroblock consists of a third block size;
an eighteenth executable portion for estimating the motion corresponding to the third partition when the summation of the fourth distortion value and the fifth distortion value exceeds the fourth predetermined threshold; and
a nineteenth executable portion for using the at least one motion vector extracted from the at least one macroblock, when the at least one macroblock consists of the first block size among the plurality of block sizes, as a motion vector corresponding to the third partition when the summation of the fifth distortion value and the sixth distortion value is less than the fourth predetermined threshold.

21. A computer program product according to claim 20, further comprising:
a twentieth executable portion for determining whether the summation of a sixth distortion value and a seventh distortion value exceeds the fourth predetermined threshold, wherein the sixth distortion value and the seventh distortion value correspond to a fourth partition of the at least one macroblock when the at least one macroblock consists of the third block size among the plurality of block sizes;
a twenty first executable portion for estimating the motion corresponding to the fourth partition when the summation of the sixth distortion value and the seventh distortion value exceeds the fourth predetermined threshold; and
a twenty second executable portion for using the at least one motion vector extracted from the at least one macroblock, when the at least one macroblock consists of the first block size among the plurality of block sizes, as a motion vector corresponding to the fourth partition when the summation of the sixth distortion value and the seventh distortion value is less than the fourth predetermined threshold.

22. A computer program product according to claim 21, further comprising:
a twenty third executable portion for determining a best inter mode among the first, second and third block sizes in which motion estimation is performed;
a twenty fourth executable portion for determining a best intra mode among candidate intra modes; and
a twenty fifth executable portion for choosing the one of the best inter mode and the best intra mode which has a lowest cost function.

23. A computer program product according to claim 14, wherein the first encoding mode comprises an inter coding mode based on temporal redundancy and the second encoding mode comprises an intra coding mode based on spatial redundancy.

24. A computer program product according to claim 21, wherein the first block size is larger than the second and third block sizes and wherein the second block size comprises a horizontal partition and wherein the third block size comprises a vertical partition.

25. A device for performing motion compensated prediction, the device comprising:
a motion estimator configured to extract at least one motion vector from at least one macroblock of a video frame, the at least one macroblock comprising a first plurality of inter modes having a plurality of block sizes;
a motion compensated prediction device configured to generate at least one prediction for the macroblock based on the at least one motion vector by analyzing a reference frame; and a processing element in communication with the motion estimator and the motion compensated prediction device the processing element is configured to compare a distortion value to a first predetermined threshold; and
the processing element is further configured to select a first encoding mode among first and second encoding modes without evaluating the second encoding mode based upon the comparison of the distortion value to the first predetermined threshold.

26. A device according to claim 25, wherein:
the processing element is further configured to estimate the motion of the at least one macroblock based on the extracted motion vector when the at least one macroblock consists of a first block size among the plurality of block sizes; and
the processing element is further configured to calculate a plurality of distortion values, each of the plurality of distortion values corresponding to a respective region of the at least one macroblock when the at least one macroblock consists of the first block size among the plurality of block sizes.

27. A device according to claim 26, wherein:
the processing element is further configured to sum the plurality of distortion values for the plurality of regions to generate a total; and
the processing element is further configured to compare the total to a second predetermined threshold and, when the total exceeds the second predetermined threshold, the processing element is further configured to select the second coding mode, without evaluating the first coding mode.

28. A device according to claim 26, wherein the processing element is further configured to generate a binary distortion map comprising a plurality of bits, wherein a value of each bit corresponds to a comparison with a third predetermined threshold and wherein each bit corresponds to a respective region of the at least one macroblock when the at least one macroblock consists of the first block size among the plurality of block sizes.

29. A device according to claim 26, wherein:
the processing element is further configured to determine whether the summation of a first distortion value and a second distortion value exceeds a fourth predetermined threshold, wherein the first distortion value and the second distortion value correspond to a first partition of the at least one macroblock when the at least one macroblock consists of a second block size among the plurality of block sizes;
the processing element is further configured to estimate the motion corresponding to the first partition when the summation of the first distortion value and the second distortion value exceeds the fourth predetermined threshold; and
the processing element is further configured to use the at least one motion vector extracted from the at least one macroblock, when the at least one macroblock consists of the first block size among the plurality of block sizes, as a motion vector corresponding to the first partition when the summation of the first distortion value and the second distortion value is less than the fourth predetermined threshold.

30. A device according to claim 29, wherein:
the processing element is further configured to determine whether the summation of a third distortion value and a fourth distortion value exceeds the fourth predetermined threshold, wherein the third distortion value and the fourth distortion value correspond to a second partition of the at least one macroblock when the at least one macroblock consists of the second block size among the plurality of block sizes;
the processing element is further configured to estimate the motion corresponding to the second partition when the summation of the third distortion value and the fourth distortion value exceeds the fourth predetermined threshold;
the processing element is further configured to use the at least one motion vector extracted from the at least one macroblock, when the at least one macroblock consists of the first block size among the plurality of block sizes, as a motion vector corresponding to the second partition when the summation of the third distortion value and the fourth distortion value is less than the fourth predetermined threshold.

31. A device according to claim 29, wherein:
the processing element is further configured to determine whether the summation of a fifth distortion value and a sixth SAD value exceeds the fourth predetermined threshold, wherein the fifth distortion value and the sixth distortion value correspond to a third partition of the at least one macroblock when the at least one macroblock consists of a third block size among the plurality of block sizes;
the processing element is further configured to estimate the motion corresponding to the third partition when the summation of the fourth distortion value and the fifth distortion value exceeds the fourth predetermined threshold;
the processing element is further configured to use the at least one motion vector extracted from the at least one macroblock, when the at least one macroblock consists of the first block size among the plurality of block sizes, as a motion vector corresponding to the third partition when the summation of the fifth distortion value and the sixth distortion value is less than the fourth predetermined threshold.

32. A device according to claim 31, wherein:
the processing element is further configured to determine whether the summation of a sixth distortion value and a seventh distortion value exceeds the fourth predetermined threshold, wherein the sixth distortion value and the seventh distortion value correspond to a fourth partition of the at least one macroblock when the at least one macroblock consists of the third block size among the plurality of block sizes;
the processing element is further configured to estimate the motion corresponding to the fourth partition when the summation of the sixth distortion value and the seventh distortion value exceeds the fourth predetermined threshold; and
the processing element is further configured to use the at least one motion vector extracted from the at least one macroblock, when the at least one macroblock consists of the first block size among the plurality of block sizes, as a motion vector corresponding to the fourth partition when the summation of the sixth distortion value and the seventh distortion value is less than the fourth predetermined threshold.

33. A device according to claim 32, wherein:
the processing element is further configured to determine a best inter mode among the first, second and third block sizes in which motion estimation is performed;
the processing element is further configured to determine a best intra mode among candidate intra modes; and
the processing element is further configured to choose the one of the best inter mode and the best intra mode which has a lowest cost function.

34. A device according to claim 25, wherein the first encoding mode comprises an inter coding mode based on temporal redundancy and the second encoding mode comprises an intra coding mode based on spatial redundancy.

35. A device according to claim 25, wherein the device is embodied as an encoder.

36. A mobile terminal comprising a video module configured to execute one or more video sequences, wherein the video module comprises the device according to claim 25.
